(19) United States
(12) Patent Application Publication
(10) Pub. No.: US 2012/0272226 A1
(43) Pub. Date: Oct. 25, 2012

(54) CONTROL PANEL AND FIRMWARE UPDATING METHOD

(75) Inventors: LAN YANG, Shenzhen City (CN); XING-XING RAO, Shenzhen City (CN)

(73) Assignees: HON HAI PRECISION INDUSTRY CO., LTD., Tu-Cheng (TW); Hong Fu Jin Precision Industry (ShenZhen) Co., Ltd, Shenzhen City (CN)

(21) Appl. No.: 13/407,772

(22) Filed: Feb. 29, 2012

(30) Foreign Application Priority Data
Apr. 19, 2011 (CN) 201110098055.7

(51) Int. Cl. G06F 9/44

(52) U.S. Cl. 717/168

(57) ABSTRACT

A control panel includes a communication interface, one or more hardware interfaces, and a firmware updating unit. A control computer is connected to the control panel via the communication interface. One or more devices are connected to the one or more hardware interfaces. The firmware updating unit determines ID information, hardware interface type information, and firmware update data in relation to a device by analyzing a firmware update command sent from the control computer, and searches out the device from the one or more devices based on the ID information and the hardware interface type information. The firmware updating unit writes the firmware update data to the device.

### BACKGROUND

1. Technical Field

Embodiments of the present disclosure relates to data updating technology, and more particularly, to a control panel and a firmware updating method.

2. Description of Related Art

Firmware refers to embedded software which controls electronic devices. A computer includes multiple components that include embedded firmware, such as a power board, a fan controller board, a sound card, a display card, for example. Presently, three manners are often used to update the firmware within these components. One manner is removing a component from the computer, and writing new data into the component using special burning tools. This manner needs to remove and re-fix the component, and different components may need different burning tools. Another manner is writing the new data into the component using software update tools under an operating system. The other manner is writing the new data into the component using special protocols under an operating system. The latter two manners do not need to remove the component from the computer. However, different components may support different operating systems, so that updating firmware within different components may need to switch the computer between different operating systems.

### BRIEF DESCRIPTION OF THE DRAWINGS

FIG. 1 is a block diagram of one embodiment of a control panel comprising a firmware updating unit.

FIG. 2 is a block diagram of one embodiment of function modules of the firmware updating unit in FIG. 1.

FIG. 3 is a flowchart of one embodiment of a firmware updating method.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

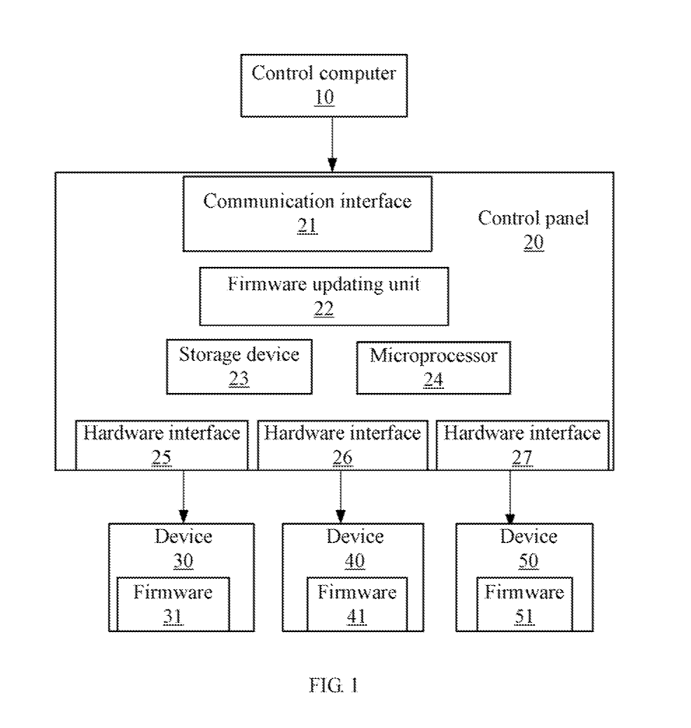

FIG. 1 is a block diagram of one embodiment of a control panel 20 including a firmware updating unit 22. In one embodiment, the control panel 20 further includes a communication interface 21, a storage device 23, a microprocessor 24, and multiple hardware interfaces with different interface types, such as hardware interfaces 25, 26, 27 shown in FIG. 1. The multiple hardware interfaces are used to connect devices with corresponding types, such as devices 30, 40, 50 which respectively include firmware 31, 41, 51 to be updated. The devices 30, 40, 50 may be installed within one apparatus (such as a computer or a server), or be installed within different apparatuses.

In one embodiment, the interface types of the hardware interface include, but are not limited to, a network interface (e.g., RJ-45), an inter-integrated circuit (I2C) bus interface, a system management bus (SMbus) interface, a component object model (COM) interface, and an accelerated graphics port. A number of the same type hardware interface may be one or more than one. The network interface may be used to connect a network card, the COM interface may be used to connect a modem, the I2C bus interface may be used to connect a power panel, and the AGP interface may be used to connect a display card.

The communication interface 21 connects a control computer 10, and is operable to receive a firmware updating command sent by the control computer 10. The firmware updating command may include information in relation to one device to be updated, or information in relation to two or more devices to be updated. The communication interface 21 may be a network interface (e.g., RJ-45), or a universal asynchronous receiver/transmitter (UART), for example.

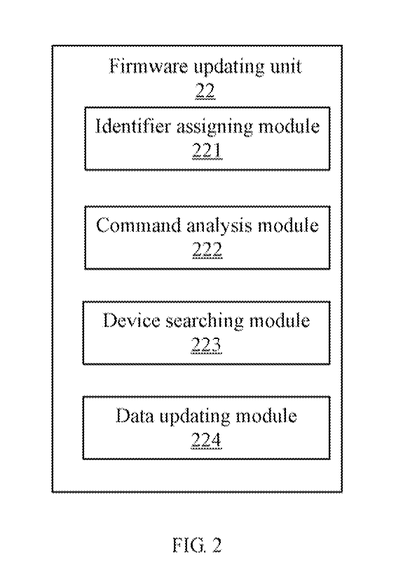

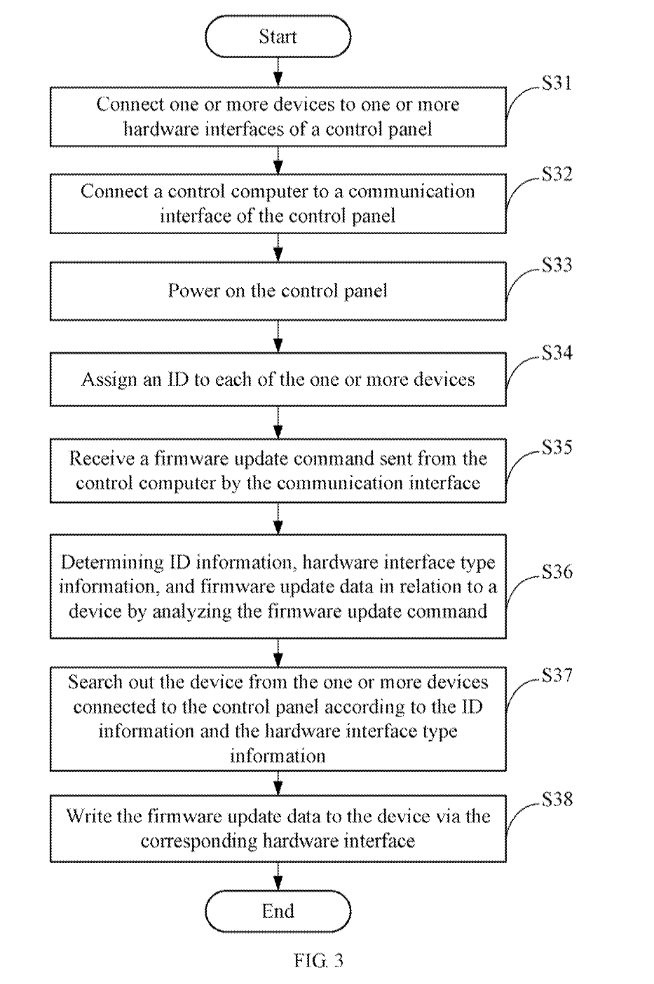

As shown in FIG. 2, the firmware updating unit 22 includes an identifier assigning module 221, a command analysis module 222, a device searching module 223, and a data updating module 224. The modules 221-224 may comprise computerized code in the form of one or more programs (computer-readable program code) that are stored in the storage device 23. The computerized code includes instructions that are executed by the microprocessor 24 to provide the functions of the modules 221-224 illustrated in FIG. 3. The storage system 23 may be a cache, an independent, or a dedicated memory.

FIG. 3 is a flowchart of one embodiment of a firmware updating method. Depending on the embodiment, additional steps may be added, others removed, and the ordering of the steps may be changed.

In step S31, one or more devices (e.g., one or more computers) are connected to the one or more hardware interfaces of the control panel 20. Each of the one or more devices is connected to a corresponding type of hardware interface. In one embodiment, the hardware interface 25 is a network interface (such as RJ-45), the hardware interface 26 is a COM port, and the hardware interface 27 is an AGP interface. If the device 30 is a network card, the device 40 is a modem, and the device 50 is a display card, then the network card may be connected to the hardware interface 25, the modem may be connected to the hardware interface 26, and the display card may be connected to the hardware interface 27. As mentioned above, the one or more devices may be installed in the same apparatus or different apparatus.

In step S32, the control computer 10 is connected to the communication interface 21 of the control panel 20. As mentioned above, the communication interface 21 may be a network interface (e.g., RJ-45), or a UART, for example.

In step S33, the control panel 20 is powered on. In one embodiment, the control panel 20 may be supplied power via the control computer, or one or more apparatuses within which the connected one or more device are installed, or an independent power source.

In step S34, the identifier assigning module 221 assigns an identifier (ID) to each of the one or more devices. For example, as mentioned above, the device 30 is the network card, and the ID assigned to the device 30 may be an Internet Protocol (IP) address of the network card. The device 40 is the modem, then the ID assigned to the device 40 may be a number of the COM port to which the modem is connected to.

In step S35, the communication interface 21 receives a firmware updating command sent from the control computer 10. As mentioned above, the firmware updating command may include information in relation to one device, or information in relation to two or more devices. The information may include ID information, hardware interface type information, and firmware update data in relation to one or more devices.

In step S36, the command analysis module 222 determines the ID information, the hardware interface type information, and the firmware update data in relation to a device by analyzing the firmware updating command.

In step S37, the device searching module 223 searches out the device from the one or more devices connected to the hardware interfaces of the control panel 20 based on the ID information and the hardware interface type information. For example, if the ID is an IP address and the hardware interface type is the RJ-45, the device searching module 223 may search out the hardware interface 25 (e.g., locate a position of the hardware interface 25) which is the network card interface and is connected the device 30 (i.e., the network card).

In step S38, the data updating module 224 updates firmware of the searched device by writing the firmware update data to the searched device. For example, the firmware update data in relation to the network card may be written into the device 30 via the hardware interface 25 for updating the firmware 31.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A control panel, comprising:
a storage device;
a microprocessor:
one or more hardware interfaces connected with one or more devices;
one or more programs that are stored in the storage device and being executed by the microprocessor, the one or more programs comprising:
an identifier assigning module operable to assign an ID to each of the one or more devices;
a command analysis module operable to determine ID information, hardware interface type information, and firmware update data in relation to a device by analyzing a firmware update command sent from a control computer that is connected to a communication interface of the control panel;
a device searching module operable to search out the device from the one or more devices based on the ID information and the hardware interface type information; and
a firmware updating module operable to update the firmware of the device by writing the firmware update data to the searched device via a corresponding hardware interface.

2. The control panel of claim 1, wherein the one or more devices are installed in the same apparatus or different apparatuses.

3. The control panel of claim 2, wherein the control panel is supplied power via the control computer, or the apparatus within which the one or more device are installed, or an independent power source.

4. The control panel of claim 1, wherein the one or more hardware interfaces are the same interface type or different interface types.

5. A firmware updating method being performed by a microprocessor of a control panel, the control panel being connected with one or more devices via one or more hardware interface, the method comprising:
assigning an ID to each of the one or more devices;
determining ID information, hardware interface type information, and firmware update data in relation to a device by analyzing a firmware update command sent from a control computer that is connected to a communication interface of the control panel;
searching out the device from the one or more devices based on the ID information and the hardware interface type information; and
updating the firmware of the searched device by writing the firmware update data to the device via a corresponding hardware interface.

6. The method of claim 5, wherein the one or more devices are installed in the same apparatus or different apparatuses.

7. The method of claim 6, wherein the control panel is supplied power via the control computer, or the apparatus within which the one or more device are installed, or an independent power source.

8. The method of claim 5, wherein the one or more hardware interfaces are the same interface type or different interface types.

9. A non-transitory storage medium storing a set of instructions, the set of instructions capable of being executed by a microprocessor of a control panel to perform a firmware update method, the control panel being connected with one or more devices via one or more hardware interface, the method comprising:
assigning an ID to each of the one or more devices;
determining ID information, hardware interface type information, and firmware update data in relation to a device by analyzing a firmware update command sent from a control computer that is connected to a communication interface of the control panel;
searching out the device from the one or more devices based on the ID information and the hardware interface type information; and
updating the firmware of the searched device by writing the firmware update data to the device via a corresponding hardware interface.

10. The medium of claim 9, wherein the one or more devices are installed in the same apparatus or different apparatuses.

11. The medium of claim 10, wherein the control panel is supplied power via the control computer, or the apparatus within which the one or more device are installed, or an independent power source.

12. The medium of claim 9, wherein the one or more hardware interfaces are the same interface type or different interface types.
